(19) United States
(12) Patent Application Publication
(10) Pub. No.: US 2015/0341798 A1
(43) Pub. Date: Nov. 26, 2015

(54) SYSTEM AND METHOD FOR MAPPING RADIO SPECTRUM INTERESTS

(71) Applicant: Spectrum Bridge, Inc., Lake Mary, FL (US)

(72) Inventor: Michelle C. Palmer, Altamonte Springs, FL (US)

(21) Appl. No.: 14/817,261

(22) Filed: Aug. 4, 2015

Related U.S. Application Data
(63) Continuation of application No. 12/256,650, filed on Oct. 23, 2008.

(51) Int. Cl. H04W 16/14; H04W 16/24

(52) U.S. Cl. CPC H04W 16/14; H04W 16/24

(57) ABSTRACT

Map-based systems and methods may be used to identify favorable opportunities for transferring apportioned spectrum use rights. Holders of spectrum use rights may generate and disseminate maps illustrating portions of available and non-available spectrum use rights. In addition, spectrum users may generate and disseminate maps illustrating desired spectrum. By comparing graphical representations of spectrum availability to desired spectrum, available spectrum use rights of holders may be matched to the desired spectrum of users. Use rights in matched spectrum may then be offered by holders and/or requested or bid upon by users.

### RELATED APPLICATION DATA

This application is a continuation of U.S. patent application Ser. No. 12/256,650, filed Oct. 23, 2008, the disclosure of which is incorporated herein by reference in its entirety.

### TECHNICAL FIELD OF THE INVENTION

The technology of the present disclosure relates generally to spectrum management, and, more particularly, to a system and methods for a mapping radio spectrum interests.

### BACKGROUND

The telecommunications industry is in the midst of change due to the rapidly improving cost and performance capability of network components. Early telecommunications systems were highly centralized and provided simple services. Today, telecommunications networks (the Internet being an example) are highly distributed, flexible, and provide a variety of services.

Wireless communications continue to gain in popularity, but wireless communications are constrained due to a lack of available, interference free spectrum that may be used for reliable communications within a geographic area. To enhance the availability and reliability of interference free spectrum, systems have been developed regionally for allocating spectrum use.

In the U.S., for example, the Federal Communications Commission (FCC) licenses spectrum in a primary spectrum market to commission licensees. As an example of current spectrum allocation, FIG. 1 shows a portion of the current U.S. frequency allocations at 2.5 GHz. As can be seen in FIG. 1, plural bands of various frequency ranges have been established, and each of these may be allocated to a corresponding commission licensee or reserved for government use. It is noted that regulations specify that stations operating in the 2568-2572 MHz range and the 2614-2618 MHz range are secondary to adjacent channel operations, may not cause interference, and must accept interference from other stations.

A secondary market exists for the commission licensees to sublease spectrum for use by other parties. Conventional secondary market leases involve the wholesaling of a spectrum holder's spectrum to another party. This is a one party to one party transaction in which use rights for an entire monolithic block of spectrum is transferred. In some situations, however, the entirety of the holder's spectrum rights are not being utilized, or may not be desired by a prospective sub-lessor. Under such circumstances, a wholesale transfer of spectrum is not desirable, but it is presently difficult to determine portions of spectrum for which a holder has use rights that may be made available to prospective users. It is even more difficult to match possible spectrum availability to desired spectrum usage.

### SUMMARY

The present disclosure describes an enhanced system and methods for mapping apportioned radio spectrum usage. The disclosed system and methods permit the tracking of the apportioning and usage of spectrum within a geographic area, which permits spectrum holders and users to identify favorable opportunities for transferring available spectrum rights from holders to users and facilitates the acquisition of spectrum for a planned use.

From a holder's perspective, the holder may access a map of a geographic area for which the holder has spectrum use rights. The holder may then identify portions of the geographic area on the map, delineating areas for which spectrum is being used, will be used, is currently subleased, will be subleased, is currently available, or will be available. In this manner, information about the current and/or future usage of the holder's spectrum may be displayed and disseminated to others. From a user's perspective, a user may access the map of the spectrum that is associated with the holder to analyze spectrum availability in a geographic area. In addition, a user may access a map of a geographic area and delineate a portion of the geographic area for which spectrum use is desired. In this manner, the desired spectrum of a user (or prospective user) may be displayed and disseminated to others.

Available spectrum use rights of holders may then be matched to the desired spectrum use rights of users. Rights to matched spectrum may then be offered by holders, and/or requested or bid upon by users.

Therefore, according to one aspect of the invention, a first method of graphically representing spectrum interests comprises determining a geographic area over which a holder entity has use-based rights in spectrum, receiving input indicative of usage of the spectrum within the geographic area, and transforming data used to define the geographic area and the input indicative of usage into display data to graphically represent the geographic area and spectrum usage on a corresponding map, the display data for the spectrum usage including data to display a visual boundary relating to a geographic extent of the corresponding spectrum use.

According to one embodiment of the first method, the method further comprises driving a display to display the map with the graphical representation of the geographic area and spectrum usage overlaid thereon.

According to one embodiment of the first method, the input indicative of spectrum usage is obtained from at least one of equipment that is deployed in the geographic area, a database that stores information relating to transfer of spectrum use rights from the holder to another party, or human input that identifies geographic boundaries for the use.

According to one embodiment of the first method, the spectrum usage relates to at least one of actual or planned transfer of spectrum use rights from the holder to another party, or use of the spectrum by the holder.

According to one embodiment of the first method, the geographic area is determined from at least one of data from a regulatory agency concerning spectrum licensing, or data maintained by the holder.

According to one embodiment of the first method, there are plural areas of spectrum usage and each is associated with a visual characteristic to identify an entity to which the use is attributed.

According to one embodiment of the first method, the display data for the geographic area and the spectrum usage are dynamically maintained for a specified period of time so that changes in spectrum usage from a first point in time to a second point in time are graphically displayable.

According to one embodiment of the first method, the second point in time is a future point in time.

According to one embodiment of the first method, portions of the geographic area that are not associated with an area of spectrum usage are portions of the geographic area that are available for transfer from the holder to a user entity.

According to one embodiment of the first method, the method further comprises receiving input indicative of a geographic area for which a user entity has a desire for spectrum and transferring the input indicative of desired spectrum onto display data to graphically represent the desired spectrum with the holder's geographic area and spectrum usage on the map.

According to one embodiment of the first method, the method further comprises identifying whether the geographic area of desired spectrum corresponds to spectrum that is available for transfer.

According to one embodiment of the first method, the method further comprises identifying whether the spectrum from the holder is available for a period of time associated with the desired spectrum.

According to another aspect of the invention, a second method of graphically representing spectrum interests comprises receiving input indicative of spectrum that is desired by a user entity, the input including a geographic boundary, and transforming the input into display data to graphically represent the geographic boundary on a corresponding map.

According to another aspect of the invention, a first program stored on computer readable medium is provided for graphically representing spectrum interests. The first program comprises executable logic to determine a geographic area over which a holder entity has use-based rights in spectrum, receive input indicative of usage of the spectrum within the geographic area, and transform data used to define the geographic area and the input indicative of usage into display data to graphically represent the geographic area and spectrum usage on a corresponding map, the display data for the spectrum usage including data to display a visual boundary relating to a geographic extent of the corresponding spectrum use.

According to one embodiment of the first program, the program further comprises logic to drive a display to display the map with the graphical representation of the geographic area and spectrum usage overlaid thereon.

According to one embodiment of the first program, the input indicative of spectrum usage is obtained from at least one of equipment that is deployed in the geographic area, a database that stores information relating to transfer of spectrum use rights from the holder to another party, or human input that identifies geographic boundaries for the use.

According to one embodiment of the first program, the spectrum usage relates to at least one of actual or planned transfer of spectrum use rights from the holder to another party, or use of the spectrum by the holder.

According to one embodiment of the first program, the geographic area is determined from at least one of data from a regulatory agency concerning spectrum licensing, or data maintained by the holder.

According to one embodiment of the first program, there are plural areas of spectrum usage and each is associated with a visual characteristic to identify an entity to which the use is attributed.

According to one embodiment of the first program, the display data for the geographic area and the spectrum usage are dynamically maintained for a specified period of time so that changes in spectrum usage from a first point in time to a second point in time are graphically displayable.

According to one embodiment of the first program, the second point in time is a future point in time.

According to one embodiment of the first program, portions of the geographic area that are not associated with an area of spectrum usage are portions of the geographic area that are available for transfer from the holder to a user entity.

According to one embodiment of the first program, the program further comprises logic to receive input indicative of a geographic area for which a user entity has a desire for spectrum and transfer the input indicative of desired spectrum onto display data to graphically represent the desired spectrum with the holder's geographic area and spectrum usage on the map.

According to one embodiment of the first program, the program further comprises logic to identify whether the geographic area of desired spectrum corresponds to spectrum that is available for transfer.

According to one embodiment of the first program, the program further comprises logic to identify whether the spectrum from the holder is available for a period of time associated with the desired spectrum.

According to another aspect of the invention, a second program stored on computer readable medium is provided for graphically representing spectrum interests. The second program comprises executable logic to receive input indicative of spectrum that is desired by a user entity, the input including a geographic boundary, and transform the input into display data to graphically represent the geographic boundary on a corresponding map.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic representation of U.S. spectrum allocations at around 2.5 GHz.

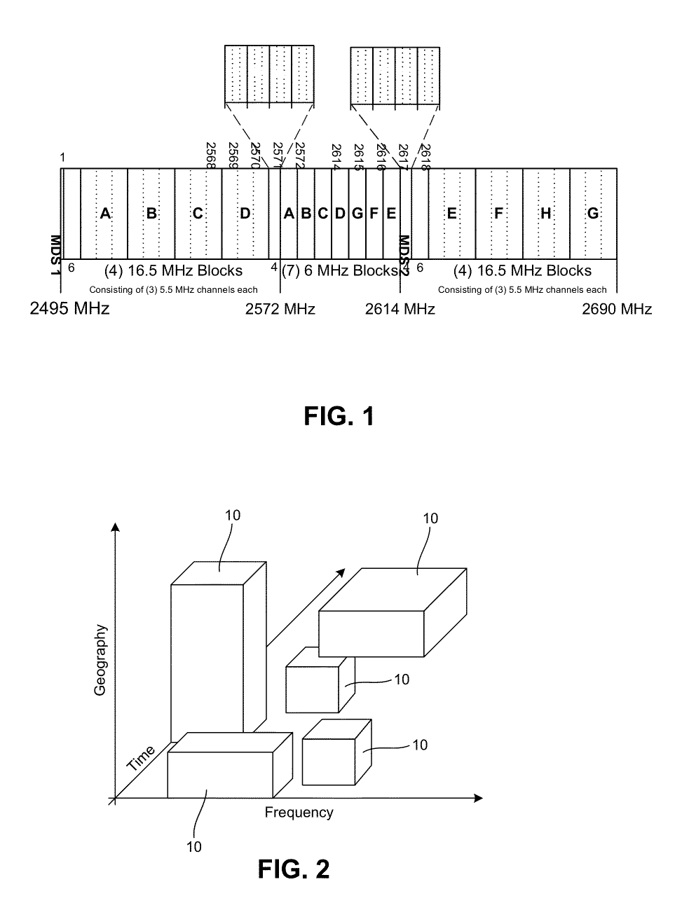

FIG. 2 is a schematic graph of blocks of spectrum use rights that may be transferred from a corresponding spectrum holder to a spectrum user.

FIG. 3 is a schematic diagram depicting operative portions of an exemplary electronic device for use with the disclosed system.

FIG. 4 is a schematic diagram depicting an exemplary communications system for providing the disclosed system.

FIGS. 5A-5C depict exemplary maps that a spectrum holder or user may access to manage and/or view spectrum usage.

FIG. 6 is a map representation of an exemplary geographic area of interest in which a holder may possess rights to use spectrum.

FIG. 7 depicts a map representation of exemplary use of spectrum for the geographic area of FIG. 6.

FIG. 8 depicts a map representation of another exemplary use of spectrum for the geographic area of FIG. 6.

FIGS. 9-11 depict an exemplary user interface for spectrum holders to interface with a map-based spectrum usage manager application.

FIG. 12 depicts an exemplary user interface constituting a query page for entering spectrum search criteria.

FIG. 13 depicts an exemplary interactive map-based display derived from the map display of FIG. 7.

FIG. 14 depicts a map representation of exemplary desired spectrum for a spectrum user.

FIGS. 15-17 depict an exemplary user interface for spectrum users to interface with map-based spectrum usage manager application.

FIG. 18 depicts a combined map representation of the exemplary holder spectrum usage of FIG. 7, and the exemplary indication of user desired spectrum use rights of FIG. 14.

### DETAILED DESCRIPTION OF EMBODIMENTS

Embodiments will now be described with reference to the drawings, wherein like reference numerals are used to refer to like elements throughout. It will be understood that the figures are not necessarily to scale. Before describing the details of exemplary systems and methods for mapping radio spectrum interests, common terms are explained.

Explanation of Common Terms

In this document, described are various entities that have a relationship to electromagnetic spectrum for use in wireless communications. One entity is a spectrum holder, or simply a holder. A holder is any entity having the authority to release spectrum use to another entity by granting the other entity access to the spectrum. The granting of access may be a temporary permission to use spectrum that is associated with the holder. Therefore, the access grant need not be a lease or a sub-lease, as defined by the FCC. The holder may be, but is not limited to, a government or regulatory agency (e.g., in the United States, the FCC), a Commission licensee (e.g., in the United States, an entity that has licensed spectrum directly from the FCC in the primary spectrum market), or a secondary market licensee.

Another entity is a spectrum user, or simply a user. A user is any entity or wireless communications system that has a need for spectrum in order to carry out wireless communications. A user also may be a holder.

Each segment of spectrum for which access permission may be transferred may be identified by several components, and each component is defined by one or more variables. Exemplary components include a time window, a frequency-based spectral mask, a geographic area, and a transmitted power limit. The time window may be a period of time that has a starting point given by a day and time and an ending point given by a day and time. Alternatively, the time window may be a period of time specified by a starting time and duration. The time window may be as short as seconds and as long as years.

The frequency-based spectral mask, as is known in the art, may be a mathematically defined set of lines applied to levels of radio transmission. The frequency-based spectral mask is generally intended to reduce interference by limiting excessive radiation at frequencies beyond a certain bandwidth. Spectral masks often include a center frequency and/or a frequency range. Also, spectral masks often include an absolute power component or a relative power component. For an absolute power component, the frequency-based spectral mask may specify that transmission beyond a specified frequency range must be below a specified power value. For a relative power component, the frequency-based spectral mask may specify that transmission beyond a specified frequency range must be below a relative power value as determined by a function, such as a specified power value below the total amount of power being transmitted.

The geographic area may include a defined geographical boundary that radios operating within the boundary may not appreciably transmit beyond. The geographical boundary specified by the geographic area may be a complex construct that relates to a contiguous or non-contiguous area. The amount of permissible transmission beyond the geographical boundary may be determined in an absolute manner or a relative manner. For an absolute manner, the geographic area may specify that transmission beyond the boundary must be below a specified power value. For a relative manner, the geographic area may specify that transmission beyond the boundary must be below a relative power value as determined by a function, such as a specified power value below the total amount of power being transmitted. In one embodiment, the function used for calculating the relative power value may include a distance parameter so that the relative power value may be calculated as a function of distance away from the boundary or other geographical reference.

The geographic area, alone or in combination with the time window, the frequency-based spectral mask and the transmitted power limit, may be established to control an amount of interference that a user system generates with respect to continued operations of the spectrum holder and/or other users.

The transmitted power limit may be a power value that radios operating in accordance with the transmitted power limit may not exceed. The transmitted power limit may be absolute or relative. The transmitted power limit may be independent of the frequency-based spectral mask and/or the geographic area. The transmitted power limit may be expressed as an average power value (e.g., average total power), a peak power value, or similar value. Exemplary transmitted power limits are 500 milliwatts (mW), one watt (W), 1,000 watts, etc.

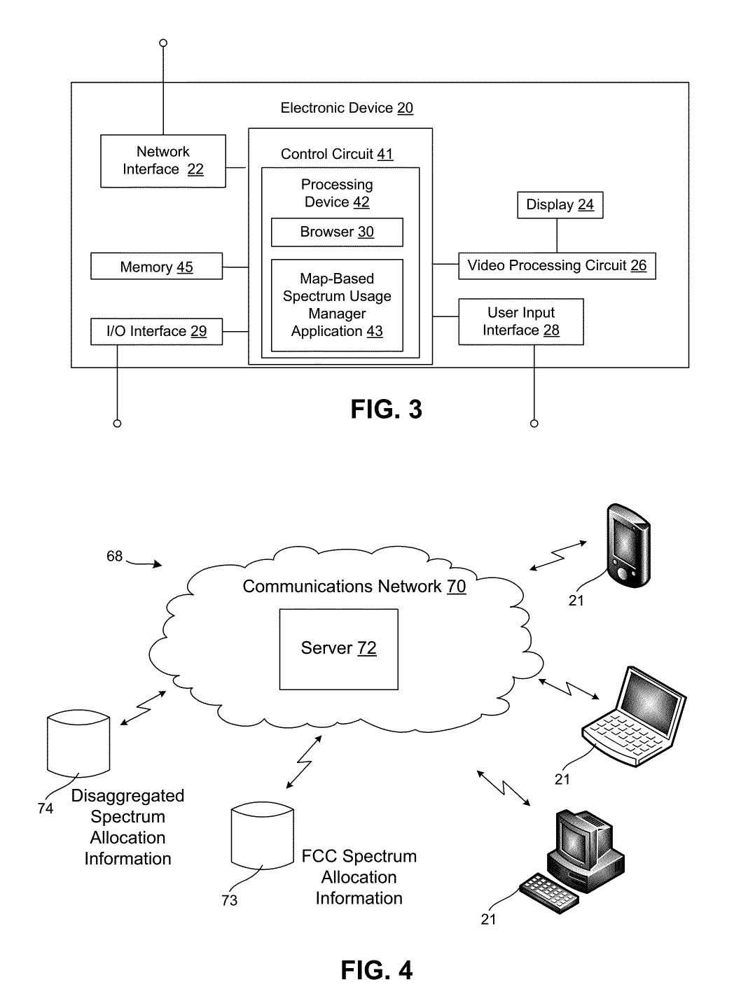

With additional reference to FIG. 2, the components that identify a block of spectrum (e.g., the time window, the frequency-based spectral mask, the geographic area, and/or the transmitted power limit) may combine to form a spectrum commodity item 10. The graph of FIG. 2 schematically illustrates blocks of spectrum in three dimensions, including time, space (or geography) and frequency which may be respectively specified with more particularity by the time window, the geographic area and the frequency-based spectral mask. Each spectrum commodity item 10 may be associated with use rights that may be transferred from a corresponding spectrum holder to a spectrum user. The spectrum commodity item may have an associated monetary or non-monetary value, or may not be associated with a value.

In many instances, a holder may be interested in apportioning some of its spectrum so that the holder may offer a resulting portion of spectrum to another entity, but the holder may maintain use rights in the remainder of the spectrum or allow another user to use other portions of the spectrum. A holder may apportion its spectrum according to any combination of geography (referred to as “partitioning” the holder's spectrum), frequency or channel plan (referred to as “disaggregating” the holder's spectrum), and time (referred to as “time-slicing” the holder's spectrum). For example, a license may be partitioned into one or more parts along any geographic boundary that is inside the original license area. Identifiable partition areas may be as small as a single city block (or smaller) or as large as a state or entire national region, as long as each partition fits inside the original license boundary. Disaggregation of licensed spectrum refers to the situation where a spectrum holder divides up a spectrum license by frequency or channels. For example, a 10 MHz license could be disaggregated into two 5 MHz parts, or ten 1 MHz parts, or any other combination totaling up to, but not exceeding the entire licensed amount. Therefore, using a combination of partitioning, disaggregation, and time-slicing, any part of a spectrum license in terms of geography, frequency (or channel) and/or duration may be identified and rights associated with that portion of spectrum may be offered to another entity or reallocated back to the holder.

Spectrum users are often interested in obtaining access to spectrum for a particular application, such as enterprise applications, two-way communications, point-to-point microwave transmissions, point-to-multipoint communications, cellular communications, mobile broadband communications, and so forth. It will be appreciated that this list is in no way exhaustive of the possible communication applications of potential users. Historically, spectrum users have gained spectrum access for their application(s) by obtaining a license or a secondary market license for spectrum that supports the desired application. In this historical sense, the spectrum associated with the license is defined by a geographical area, a spectral mask, a frequency (or set of frequencies) and one or more service rules. In the U.S., service rules are typically specified under an FCC “Part” number. The service rules under each license refer to an application and/or the type of radio technology that may use the licensed spectrum. While the service rules are typically commensurate with the user's desired application, the licensed spectrum effectively is limited for a stated purpose, although several types of uses may fall within the purpose as governed by the service rules associated with the license.

In some situations, a user may be interested in a targeted transfer of spectrum use rights, rather than a wholesale transfer of a spectrum holder's spectrum as found in conventional secondary market leases in which an entire monolithic block of spectrum is transferred. In these situations, the user may seek access to one or more portions of a holder's rights. For example, a user may desire access to spectrum limited by a variety of criteria, such as a disaggregated frequency band, a partitioned geographic area, and time. For example, a user that seeks to provide broadband services to a specific location may desire 2.5 MHz of bandwidth in two adjacent zip codes, beginning on a predetermined date. It will be appreciated that other users may desire spectrum rights in accordance with different criteria.

In addition, holders that have use rights to spectrum may seek to allow others to use spectrum that is otherwise unused or underutilized, or will become unused or underutilized in the future. For example, within a given geographic area and for a given frequency range and time, a holder may use the spectrum in only a portion of the geographic area. A holder also may have transferred use rights in the spectrum that span other portions of the geographic area. Still, there may be geographic gaps in the usage of the spectrum for the geographic area, or, in other words, there may be portions of the geographic area in which a holder has rights, but the spectrum is not being used to its fullest extent. These portions of spectrum may provide a holder additional opportunities to transfer portions of spectrum, thereby increasing the potential value of the spectrum as a whole to the holder. From the perspective of a prospective user, spectrum that may be disaggregated, partitioned, and/or time-sliced from the balance of a holder's spectrum may provide opportunities to acquire spectrum use rights in a more targeted manner suitable to the prospective user's needs. Therefore, there is a need to facilitate matching of a holder's available spectrum with a user's spectrum needs.

In addition, although it may be contemplated that a holder may apportion (partition, disaggregate, and/or time slice) its spectrum for offering to other entities, this need not be the case. A holder also may apportion its spectrum rights for its own internal usage. For example, a large corporate entity or governmental body may apportion its spectrum for usage by respective subsidiaries, divisions, and the like.

The type or types of radio devices that use the spectrum are not germane to the underlying systems and methods described herein. As such, the systems and methods may be applied in any operational context for wireless communications, and wireless communications are expressly intended to encompass unidirectional signal transmissions (e.g., broadcasting of a signal for receipt by a device without response) and to encompass bidirectional communications where devices engage in the exchange of signals. The methods and systems may be applied to dumb and/or cognitive radio devices. The methods and systems may be applied to licensed or unlicensed spectrum. Furthermore, the methods and systems are generic to modulation schemes, harmonic considerations, frequency bands or channels used by the radio devices, the type of data or information that is transmitted, how the radio devices use received information, and other similar communications considerations. Thus, the systems and methods have application in any suitable environment.

The term “control circuit” or “controller” refers to any structural arrangement that implements a stated control function, and may include dedicated circuit components, firmware, and/or a processor that executes logical instructions. In one embodiment, functional operations that are described as being implemented in the context of software may be implemented as one or more programs that are stored on computer or machine readable medium and that are executed by a processor that forms part of a control circuit.

Exemplary Map-Based Radio Spectrum Usage Management System

System Components

The following describes a map-based radio spectrum usage management system. The system is described primarily with respect to spectrum allocation based on spectrum allocated in the United States (U.S.) by the FCC. It will be appreciated, however, that the system may be used in connection with spectrum allocated by regulatory agencies other than the FCC, including non-U.S. national or regional regulatory agencies. The system may be accessed by spectrum holders and users with any suitable electronic device having a display and an input interface. Examples of suitable electronic devices may include a desktop or laptop computer.

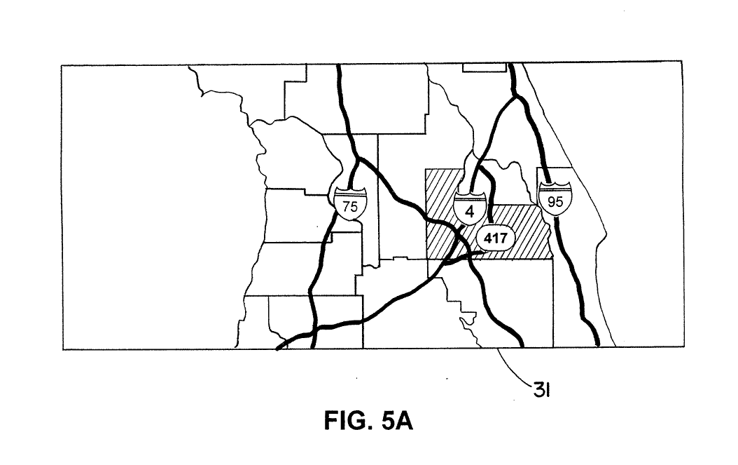

FIG. 3 represents a functional block diagram of operative portions of an electronic device 20 that may execute a map-based spectrum usage manager application 43. The application 43 may be embodied as executable program code that is resident in and executed by the electronic device 20. The electronic device 20 may include a controller that executes the program code stored on a computer or machine-readable medium. The controller may include a control circuit 41 and/or a processing device 42. Application 43 may be a stand-alone software application or form a part of a software application that carries out additional tasks related to the electronic device 20. It will be apparent to a person having ordinary skill in the art of computer programming how to program an electronic device to operate and carry out logical functions associated with application 43. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention. Also, through the following description, exemplary techniques for implementing a map-based spectrum management system and method are described. It will be appreciated that through the description of the exemplary techniques, a description of steps that may be carried out in part by executing software is described.

The described steps are the foundation from which a programmer of ordinary skill in the art may write code to implement the described functionality. As such, a computer program listing is omitted for the sake of brevity. However, the described steps, when implemented in software and executed by a processor or control assembly, describe the structure of an apparatus.

The electronic device 20 may include a browser 30, such as a web browser for accessing content over the Internet or comparable external network. The browser may be a stand-alone function, or may be executed by the control circuit 41. A network interface 22 may be present for establishing a wired or wireless interface with an external network.

The electronic device 20 may include a display 24 for displaying information to a user. The display 24 may be coupled to the control circuit 41 by a video processing circuit 26 that converts video data to a video signal used to drive the display. The video processing circuit 26 may include any appropriate buffers, decoders, video data processors and so forth.

The electronic device 20 may include a user input interface 28 that permits a user to enter a variety of text, data, control, and other inputs. The user input interface may include one or more input devices, examples of which may include a keyboard, keypad, soft keys, mouse, pointer, stylus, and similar input instruments, and combinations thereof. In conjunction with one or more of these user input devices, the display 24 may include a touch screen surface for receiving inputs from a user directly onto the display.

The electronic device 20 may include an I/O interface 29 that permits connection to a variety of conventional I/O devices. Such devices may include equipment for transmitting or manipulating content obtained by electronic device 20, such as printers, faxes, scanners, and the like.

Although the various components of the electronic device 20 are depicted in FIG. 3 as being integrated into a single device, other component configurations may be employed. For example, in a laptop computer, the various components may be integrated into a single physical device, as depicted in FIG. 3. Alternatively, the various components may be segregated into separate physical devices. For example, electronic device 20 may be a desktop computer in which the display and one or more user input interfaces are physically separate from the other components. As further described below, the spectrum usage management features of the application 43 may be hosted by a network server that is accessible by one or more client devices over the network. In this embodiment, the browser 30, user input interface and the display would be components of the client devices, with program application 43 being accessed from and executed by the network server. Other component configurations may be employed as well.

As a map-based system, a user may employ the electronic device 20 to access a map for display on the display 24. A user may then use the input interface 28 to select more targeted regions within the selected geographic area for which to search and/or manage spectrum.

Conventionally, spectrum allocation information is contained in one or more databases that are accessible over the Internet or a comparable network. For example, the FCC maintains text-based databases regarding spectrum that has been allocated to primary market licenses, although other private or government organizations may compile comparable information into a database. In addition, spectrum holders or other interested entities (e.g., sublicenses) may compile information regarding spectrum usage and available spectrum rights. For instance, deployed radius and/or spectrum sniffers may generate data from which current spectrum usage may be determined. Also, historical spectrum usage and/or other knowledge sources may be used to predict future spectrum usage. In other embodiments, spectrum usage information may be derived from a membership-based system, in which spectrum holders and users cooperate to provide a database of spectrum usage information. For holders, the incentive for joining such a membership-based system is the improved capability for holders to widely publicize the existence of available spectrum, which may then be offered to users. For users and prospective users, the incentive is a convenient and efficient manner to identify desired and available spectrum, for which use rights may then be requested or bid upon from holders. The result is the enhanced ability to transfer spectrum use rights from holders to users.

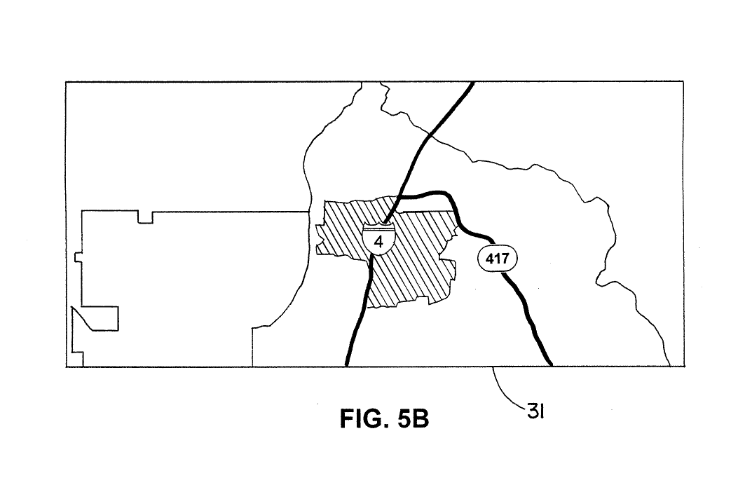

FIG. 4 depicts several electronic devices that comprise client devices 21 operating as part of a communications system 68, such as the Internet. The system 68 may include a communications network 70 having a server 72 (or servers) that communicate with participating electronic devices (e.g., the client devices 21). As will be appreciated, the server 72 may be configured as a typical computer system used to carry out server functions and may include a processor configured to execute software containing logical instructions that embody the functions of the server 72 and a memory to store such software.

In one embodiment, the server 72 may host the application 43 for access by the client devices 21. For instance, the application 43 may have a front-end interface that may be accessed by client devices 21 using conventional Internet browsing functionality.

The application 43, when executed by a user device or hosted remotely, may access a database 73 containing FCC spectrum allocation information, and although it is represented as a single database for simplicity in the figure, it will be appreciated the database 73 may comprise a network of separate databases containing the FCC spectrum allocation information. Also as stated above, the database 73 may be maintained by a third party that has compiled similar information. In addition, the communications system may include a second database 74 containing information regarding spectrum usage (including apportioned spectrum usage) and availability of at least one holder. Although shown as a single database, it will be appreciated that spectrum usage information may be spread over a plurality of databases. In addition, the FCC spectrum allocation information and the apportioned spectrum information may be wholly or partly combined into one or more databases.

Holder Usage Manager

The disclosed system and methods may be employed by spectrum holders to disseminate information regarding spectrum usage and availability, and to otherwise manage spectrum usage. A holder may begin by accessing the application 43. As a map-based system, a holder may access a map of a particular geographic region or area of interest.

For example, a holder may select a geographic region by region of the country, state, one or more counties, cities, zip codes, etc., (or portions of any thereof), latitude/longitude coordinates, or any other boundaries as may be convenient for a user. A holder also may select a geographic area based on an FCC delineation. As is known in the art, the FCC has established multiple, and sometimes overlapping, categories for dividing the United States into areas or regions for the purpose of assigning area-based spectrum licenses, referred to herein as “FCC defined areas”. For example, the FCC has divided the United States into 51 Major Trading Areas (MTAs), which are further subdivided into approximately 500 basic trading areas (BTAs). Other FCC geographic categories include Cellular Market Areas, Economic Area Groupings, and others. The geographic area also may be defined by a geographic emission mask that has been constructed for purposes of making unused or underutilized spectrum into a tradable commodity. The partitioning of spectrum based, in part, on geographic emission marks is explained in greater detail in U.S. patent application Ser. No. 12/042,543, the disclosure of which is incorporated by reference in its entirety.

It will also be appreciated that the selected geographic area may be arbitrary with respect to the geographic boundaries associated with the spectrum. In other words, a geographic area of interest does not necessarily have to correspond with a radio spectrum boundary (although the geographic area of interest may do so). For example, if a county were to be defined as the geographic area of interest, the geographic scope of a particular radio spectrum may completely cover the county, encompass parts of other counties outside the county of interest, cover only a part of the county, none of the county, and the like. Accordingly, a holder may have a variety of options for selecting a geographic area to be the basis for initiating the map-based spectrum usage manager.

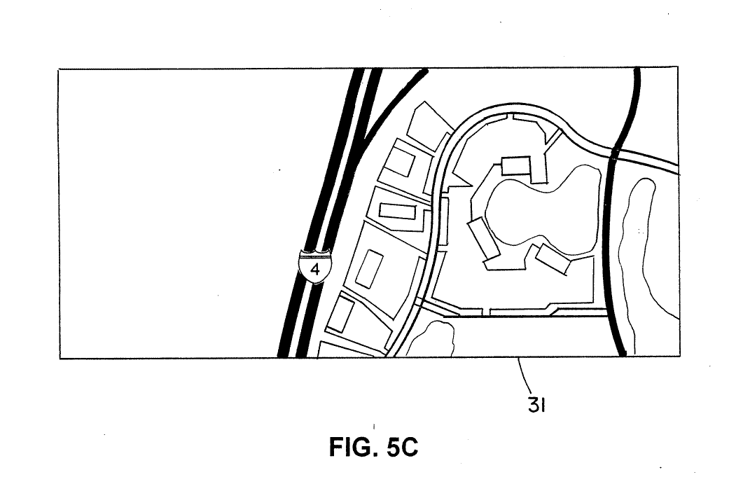

FIGS. 5A-5C depict exemplary maps 31 that a spectrum holder may use to manage spectrum use rights. FIG. 5A is an aerial map 31 of a region corresponding to a portion of central Florida, from which a holder may select a more specific region. For example, one county within the regional map is highlighted, and FIG. 5B depicts a map 31 of the particular county highlighted from FIG. 5A. A holder may provide additional specificity. For example, one zip code is highlighted within the county of FIG. 5B. Further narrowing of the area may result in the selection of an even smaller area such as an office park as shown in the exemplary map 31 of FIG. 5C. In one embodiment, the maps may be satellite images. Other maps, such as street maps, combined satellite images and street maps, topological maps, etc. may be used. It will be appreciated that a holder may select a geographic area in a variety of ways. In one embodiment, a holder may progress from a larger regional map through maps of smaller regions, as illustrated in the progression from FIG. 5A to 5C. Alternatively, a holder may simply select the specific geographic area of interest without accessing intermediary maps.

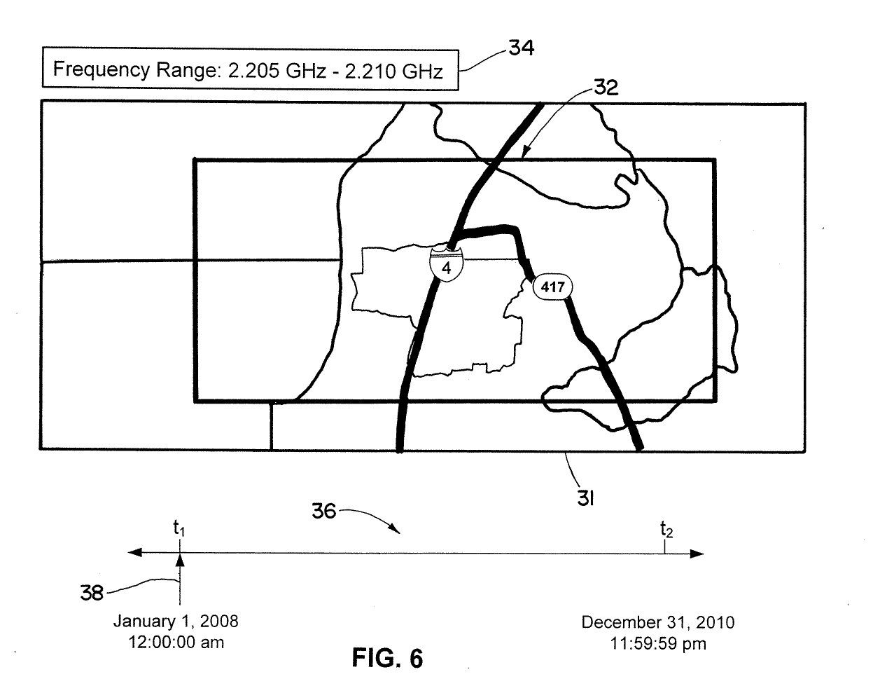

An example of the operation of the system is described in connection with FIG. 6. In the following example, a hypothetical spectrum holder XYZ Wireless, Inc. holds an FCC license to spectrum rights in a substantial portion of the county shown in FIG. 5B. In particular, licensed spectrum for a geographic area 32 may be specified by a spectral mask, inclusive of a specified frequency range, and for a specified duration. As a description example, it will be assumed that the frequency range is 2.205 GHz to 2.210 GHz and the duration may extend from Jan. 1, 2008 at 12:00:00 a.m. through Dec. 31, 2010 at 11:59:59 p.m. It will be appreciated that these parameters are examples, and the spectral mask and time window may be varied. In the illustrated embodiment, the frequency range is displayed in a frequency information box 34 and a time window (which may or may not be the same as the duration of the license) is shown in a time line 36.

FIG. 6 depicts a map of the exemplary spectrum use rights held by XYX Wireless. In this figure, the selected county is displayed in a two-dimensional, aerial-view map 31. As further described below, the geographic map 31 may provide a map base on which spectrum allocation information may be overlaid. The map 31 may be displayed on the display 24 of the electronic device 20 or client device 21. The geographic area 32 corresponding to the spectrum use rights of XYZ Wireless is indicated on the map with a box indicator boundary and shading. In other words, XYZ Wireless holds rights to spectrum usage, licensed from the FCC, for the entire geographic area 32 defined by the box indicator. Although the boundary is rectangular, shapes of geographic areas for which a holder has spectrum use rights may vary, sometimes being irregular and/or discontinuous.

FIG. 6 also includes a graphical user interface (GUI) feature in the form of the exemplary time line 36 for a time period from t₁ to t₂. In the specific example of FIG. 6, the time period of the time line 36 corresponds to the example licensed time window described above. Alternatively, t₁ or t₂ may be the current time, or t₁ and/or t₂ it may be some designated time in the future at which a holder may allocate or transfer spectrum use rights. Time t₁ and/or t₂ may also be in the past should a user desire historical spectrum allocation information. The time line further permits a holder to select a specific time about which spectrum usage may be viewed or managed. An indication arrow 38 is set to time t₁, which corresponds to the map display. A user may manipulate the indication arrow 38 or make some other user input to select a time at which spectrum allocation information is desired. It will be appreciated that the visual characteristics of the time line may be varied, or a visual representation of time other than a time line may be employed. Regardless of how time is represented, a change in the selected time may alter the map commensurately.

In the example of FIG. 6, therefore, the figure depicts the extent of XYZ Wireless' licensed spectrum as it was on Jan. 1, 2008 at 12:00:00 a.m. Using this map base, the map may be populated with information regarding how the spectrum is being used as based on actual or predicted use information, and/or with planned use information derived from human knowledge. In the disclosed system and methods, the use information may be transformed into readable display data that may be overlaid on the map base, for example, in the form of spectrum segments arranged according to corresponding geographic boundaries.

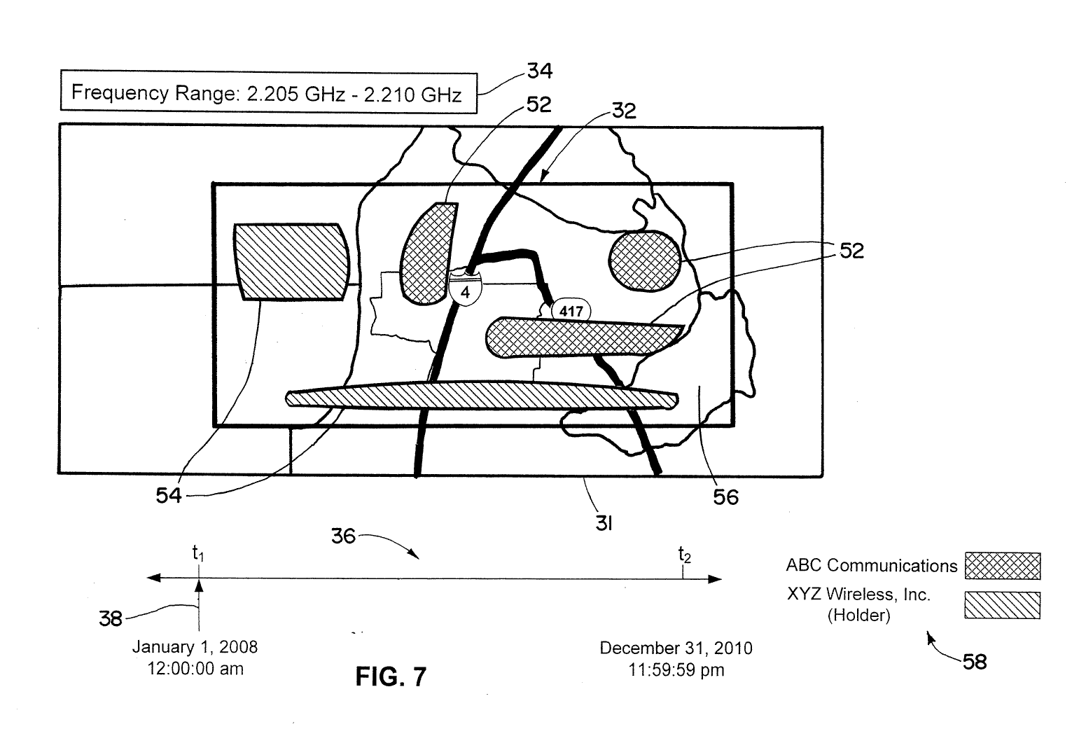

FIG. 7 depicts exemplary apportioned use of the holder's spectrum rights depicted in FIG. 6. As before, designation 32 represents the entirety of the geographic area of the holder's spectrum rights under the FCC license. In the illustrated example, subleased regions 52 have been subleased to another communications company, e.g., hypothetical ABC Communications Company. In addition, regions 54 designate areas in which the holder utilizes the spectrum. The holder actually may be using the spectrum of regions 54, or simply may have reserved these regions for future usage or an anticipated upcoming transfer. The different users (in this context the holder is also a user) are distinguished using patterns on the map. A legend 58 may provide a key as to which patterns correspond to which user. It will be appreciated that the precise format of the map may be varied. For example, other formats may be used to distinguish the various users, such as color coding.

FIG. 7 also contains region 56 which constitutes portions of the holder's spectrum rights that have neither been subleased, nor designated as holder usage areas. Region 56, therefore, represents portions of unused spectrum. As unused spectrum, region 56 may be available to transfers to other users looking for access to spectrum within region 56 or a portion thereof, or that may be available for additional use by the holder.

Issues may arise concerning interference of proximate or adjacent spectrum usages with one another. It will be appreciated, therefore, that in drawing areas of spectrum use (e.g., areas 52 and/or areas 54) and areas of desired spectrum as described below, the areas may be drawn with consideration to interference avoidance. In other words, a displayed spectrum region may be considered to include the geographic boundary of actual or desired usage plus an appropriate surrounding geographic buffer to minimize interference with nearby usages.

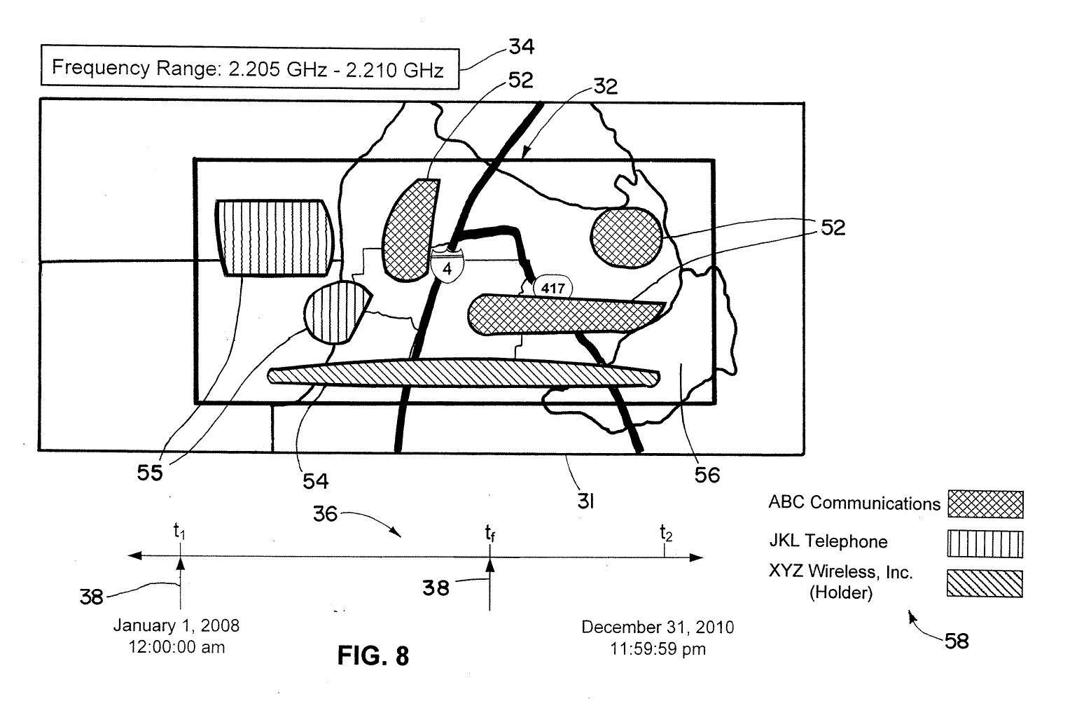

A holder also may use the system to manage the usage of spectrum. For example, suppose XYZ Wireless desires that (or has already arranged that) the use of spectrum change at some future time t_{f} within the time window of the FCC license. FIG. 8 depicts an exemplary use of spectrum at time t_{f}. In particular, at time t_{f} two regions 55 are shown to be subleased to another user, e.g., hypothetical JKL Telephone, Inc. One of the newly subleased regions 55 was previously unused, and one was previously one of the holder usage regions 54. The regions 52 subleased to ABC Communications have not changed. The legend 58 has updated to reflect the use at time t_{f}. In addition, similar to FIG. 7, region 56 indicates portions of unused spectrum, now at time t_{f}. In this manner, a holder may create a map display of the usage and availability of spectrum at any time within the holder's time window of rights.

Initially, spectrum use information may be collected from deployed devices (e.g., radius and/or sniffers) and/or input by a user. Such information may then be stored, such as in the database 74 of FIG. 4. Similarly, a user and deployed devices may update the information to reflect changes in the usage of spectrum over time, and/or to predict future use. The information may then be accessed by other participants in the system. For example, a prospective user may access the information to determine what spectrum may be available within a selected geographic area, and for a particular frequency and time period. If available spectrum is desirable to a user (in terms of geographic boundary, frequency, and time) a user may seek to acquire such spectrum rights to a disaggregated portion of the spectrum associated with the holder.

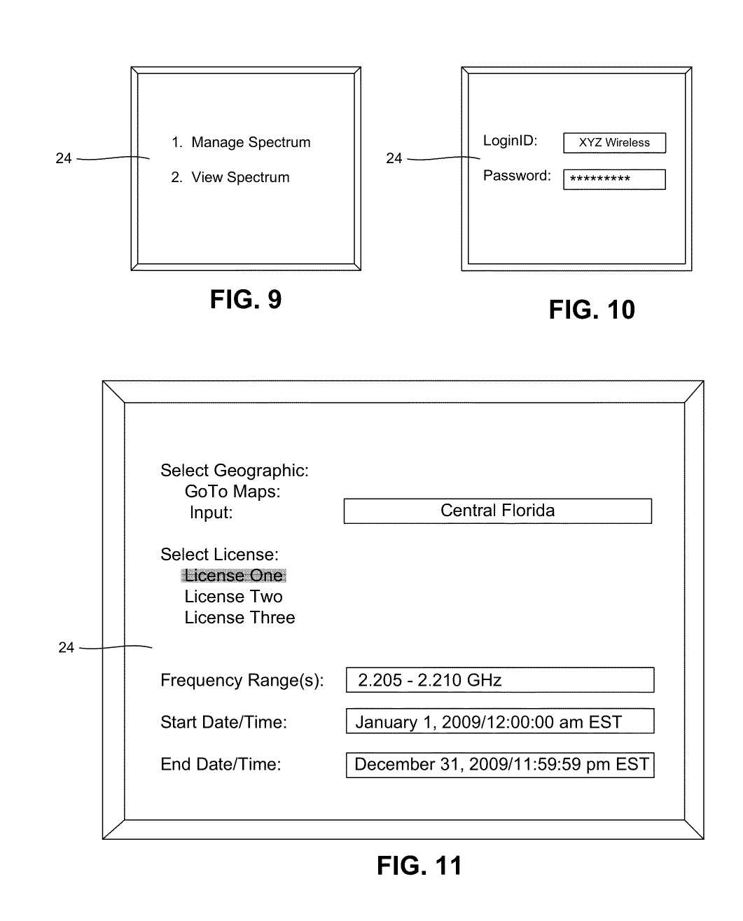

FIGS. 9 to 11 depict an exemplary graphical user interface for holders to interface with the described map-based spectrum usage manager application 43. It will be appreciated that the interface and menu system described below constitute an example and may be varied. Other interface systems having differing specific menus, graphical features and format may be employed.

FIG. 9 depicts an exemplary opening screen as it may appear on the display 24 of an electronic device 20 or client device 21. A holder may be provided, for example, with options such as “Manage” or “View” spectrum use. In a first example, it will be assumed that a holder selects the “Manage” option. Selections from this or other screen views described herein may be made from the display 24 using the input interface 28.

As described above, for a given holder, managing spectrum use may include designating areas of used spectrum and/or areas of available spectrum. Such designation may include drawing on the map and/or using automated spectrum usage analysis tools. It is noted that the term “spectrum use” includes both the transfer of spectrum use rights and use of the spectrum by the holder for wireless communications. In one embodiment, a party that has acquired spectrum use rights, such as through a secondary lease or exchange-based transfer, may manage the acquired spectrum using the application 43. FIG. 10 depicts an exemplary login screen for managing spectrum. A holder may input a login ID, password, and/or other security information to obtain access to management functions.

FIG. 11 depicts an exemplary geographic input screen from which a user of the system may manually select a geographic area of interest. The geographic area may be input by typing in a geographic area, selecting a geographic area from a pull-down menu, by navigating on a displayed map, or by other means. For example, as shown in FIG. 11, a holder may have a “Go To Maps” option that permits a holder to select a geographic area of interest from a national map or regional maps, similar to those of FIGS. 5A-5C, or from another menu, such as a menu of zip codes, city names, county names, FCC defined areas, etc. In this particular example, the holder has used the input option and typed in or selected “Central Florida” as an area of interest. The interface of FIG. 11 may also permit a holder to input a frequency range (or some other parameter related to spectral mask, such as center frequency), time window or other value (e.g., transmit power).

Alternatively or additionally, as shown for example in FIG. 11, a user may input or select an FCC license to which the holder is a party. By selecting an FCC license, the holder effectively would be selecting a geographic area served by the selected license. For example, by selecting Central Florida in FIG. 11, the holder has called up licenses in that region (exemplary Licenses One, Two and Three). In this specific example, the holder has selected License One as indicated by the shading. A more specific geographic area of interest may be extracted from the license information, combined with additionally specified information. In one embodiment, the system also may automatically extract the frequency range and time window from information related to the license. Such information may be extracted by accessing a database containing FCC spectrum allocation information, such as the database 73 of FIG. 4, or a database maintained by the holder.

Once a geographic area is selected, a holder may be presented with an interactive map of the selected geographic area that provides a map base, and may manage the use and allocation of spectrum as described above in connection with FIGS. 6-8. Actual spectrum use data and/or system user input may be transformed into display data for overlaying on the map base. For instance, a holder may delineate the regions of used spectrum, such as areas for which spectrum use rights have been transferred, areas for which the holder uses spectrum and/or areas that are reserved for some future purpose. A holder may block off or mask portions of the map by drawing on the map as a touch screen surface, entering coordinates, using a graphics or illustrator application, or by other means. The time line 36 also may be interactive. For example, a holder may move the time indication arrow 38 with a mouse pointer or similar input instrument. It will be appreciated that various options may be provided for holders to interact with the usage manager maps.

Referring again to FIG. 9, a holder may have the option of viewing graphical spectrum information without the management features. In other words, in the viewing mode a holder would not be able to alter the usage information. However, the graphics may be updated using received data, such as changes in actual spectrum usage, new transfers of spectrum use rights and/or expired transfers of spectrum use rights. Because the allocation information may not be altered in the viewing mode, security is less of a concern. The viewer option, therefore, may be used by a holder to view its own spectrum usage or the spectrum usage of another holder. As further described below, users, prospective users and other participants also may employ the spectrum viewer to determine what segments of spectrum may be available.

For a given geographic location at a given time, there may be plural discernable portions of used spectrum. If all such areas of spectrum over multiple frequency bands, multiple holders and/or multiple points in time were displayed on a single map, the result may be a cluttered display that is difficult to comprehend and navigate. In one embodiment, therefore, a viewer may limit the display to a particular frequency range or ranges, a particular holder or holders, a particular time or time range, or other criteria of interest. Additional criteria may be imposed to limit the search scope and resultant display, such as power limits, usage restrictions, applicable FCC service rule(s), and the like.

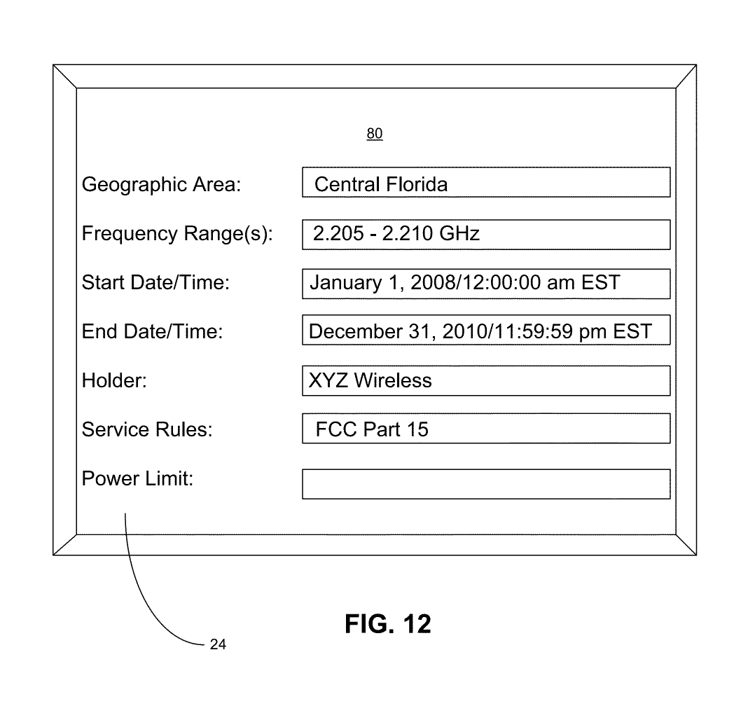

FIG. 12 depicts an exemplary user interface constituting a query page 80 for entering search limits. The query page 80 may be displayed on the display 24 of the electronic device 20 or client device 21. It will be appreciated that FIG. 12 is an example, and the content and format of the query page may be varied. Search criteria may be entered with a keyboard, keypad, selection from a menu, or by other conventional means. As part of this map-based search system, a user may enter a geographic category for defining the geographic areas of interest. In this example, the user has selected Central Florida as the geographic area of interest. The user also has limited the searched frequency range, the time window, the holder, and the service rule. In one embodiment, the specified time range may limit results to spectrum segments having any portion within the specified range. Alternatively, the time delineation may limit results to spectrum segments wholly within the specified range, or having some threshold proportion within the specified range. In the illustrated example, XYZ Wireless has been entered into the holder field and FCC Part 15 has been entered in the service rules field. Other fields may allow for the specification of a particular application (e.g., the manner in which the spectrum will be used) and/or the type of radio technology. While the service rules are typically commensurate with the user's desired application, the licensed spectrum effectively is limited for a stated purpose, although several types of uses may fall within the purpose as governed by the service rules associated with the license. Note that one search field, Power Limit, has been left blank in this example. Blank search fields would not operate to narrow this exemplary search.

The results of this exemplary search may be displayed in a map-based form. For example, the specific search criteria of FIG. 12 may result in the display of FIG. 7. In one embodiment, a user may navigate the mapped search results to access additional information regarding a particular portion of the spectrum. For example, a user may employ a cursor, pointer, touch screen or any other navigational tool to select a particular portion of the spectrum.

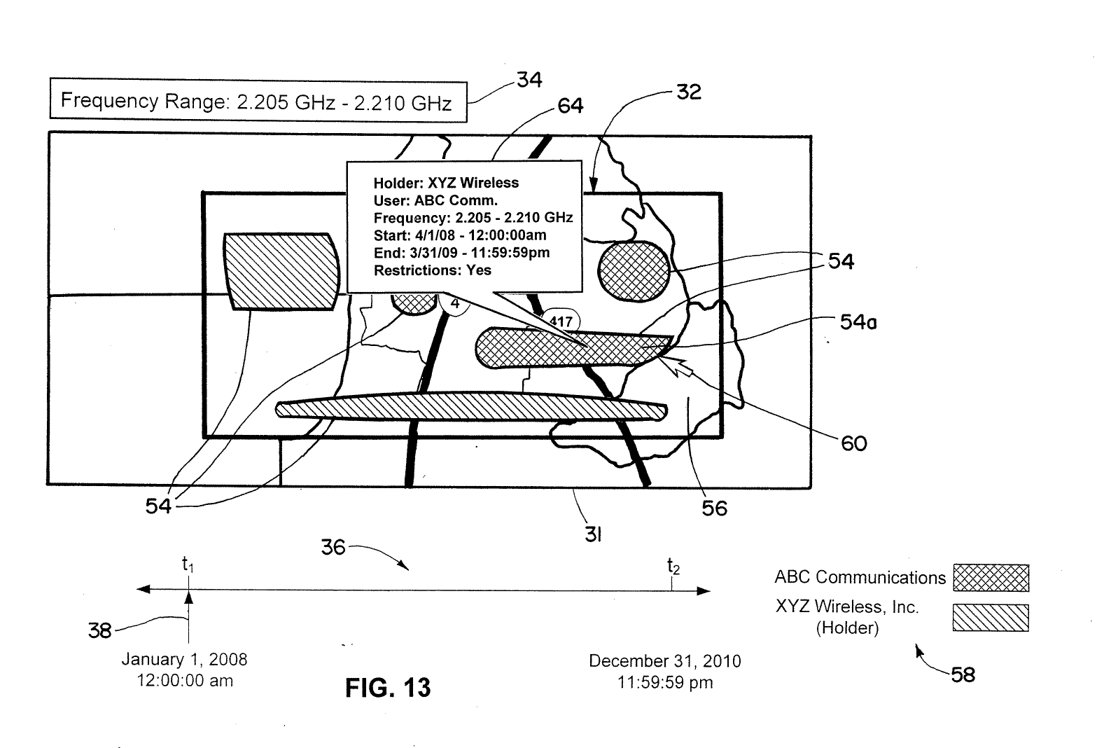

FIG. 13 depicts an exemplary interactive map-based display of spectrum allocation information derived from the map display of FIG. 7. In this example, a mouse pointer 60 appears on the map which permits a user to navigate the map. The mouse pointer may be used to select a specific spectrum segment in the display. The mouse pointer may also be used to select a specific time by moving the time indication arrow 38 along the time line 36. In this example, a user has moved the mouse pointer to one of the areas 54, and specifically to the patterned block 54a of subleased spectrum. A “pop-up” text balloon 64 has appeared on the map display, and the text balloon may include some basic information about this particular block of spectrum. For example, the balloon identifies the FCC license Holder as XYZ Wireless, and indicates that this portion has use rights held by ABC Communications. Frequency and use rights duration are also shown. If the user were to move the mouse pointer to point to another spectrum segment, a new text balloon would appear for that spectrum segment, and so on. As stated above, a mouse pointer is an exemplary navigation tool, but other navigation tools may be used. In one embodiment, the map includes a touch screen surface for navigating the map directly on screen.

In the current example, the text balloon 64 also contains a “Restrictions” field, which, in this example, contains a “Yes” entry which indicates that the spectrum usage is restricted in some manner. For example, usage may be restricted by having a power limit, or be subjected to one or more FCC service rules. As state above, FCC service rules typically are specified under an FCC Part number. It will be appreciated that text balloon 64 is an example, and that the specific content and format of the display spectrum information may be varied.

In one embodiment, a user may obtain additional details regarding the particular spectrum segment by selecting the text balloon 64 (or comparable representation). The selection may be made by a user with a “mouse click” or by other conventional means of selecting items from an electronic display. Once the text balloon is selected, more detailed text information may be viewable in addition to or instead of the map, such as spectrum mask data, time window of use rights and geographic boundaries, contact or other corporate information regarding the holder or entity with use rights, a description of the current usage, details describing any applicable restrictions and FCC service rules, and the like. It will again be appreciated that the content and format of the detailed spectrum information may be varied.

Referring again to FIG. 3, maps, spectrum usage information, and other related information may be stored in the electronic device 20, such as in memory 45. Such information also may be transformed or transmitted via the I/O interface 29 to various peripheral I/O devices, such as printers, faxes, external storage devices, and the like. Information may also be transmitted to other electronic devices via the network interface 22 over the communications system 68 (see FIG. 4) by any conventional means.

Referring again to FIG. 4, spectrum use information and other related information may be transmitted over the network from the server 72 and/or the client devices 21, and stored in the database 74. The information may then be accessed by client devices of other holders, users, prospective users, and other participants in the system.

With the described system and methods, a holder of licensed spectrum may visually observe and track use of spectrum associated with the holder. In particular, holders may generate map-based information regarding the usage and availability of associated spectrum. The map-based information may be accessed by other holders, users, and prospective users to identify favorable opportunities for transferring use rights to unused or underutilized spectrum.

User Usage Manager

The described system and methods may also be employed by spectrum users (and prospective users). Specifically, a user may employ the system to ascertain spectrum availability and/or to provide an indication of a geographic area for which spectrum is desired. The user usage manager is described by reference to the following example. It will be appreciated that the details of the example may be varied.

For example, suppose a hypothetical company, DEF Internet, desires to provide broadband within a portion of the county depicted in FIG. 5B. DEF Internet intends to provide such services from Jan. 1, 2009 at 12:00:00 a.m. through Dec. 31, 2009 at 11:59:59 p.m.

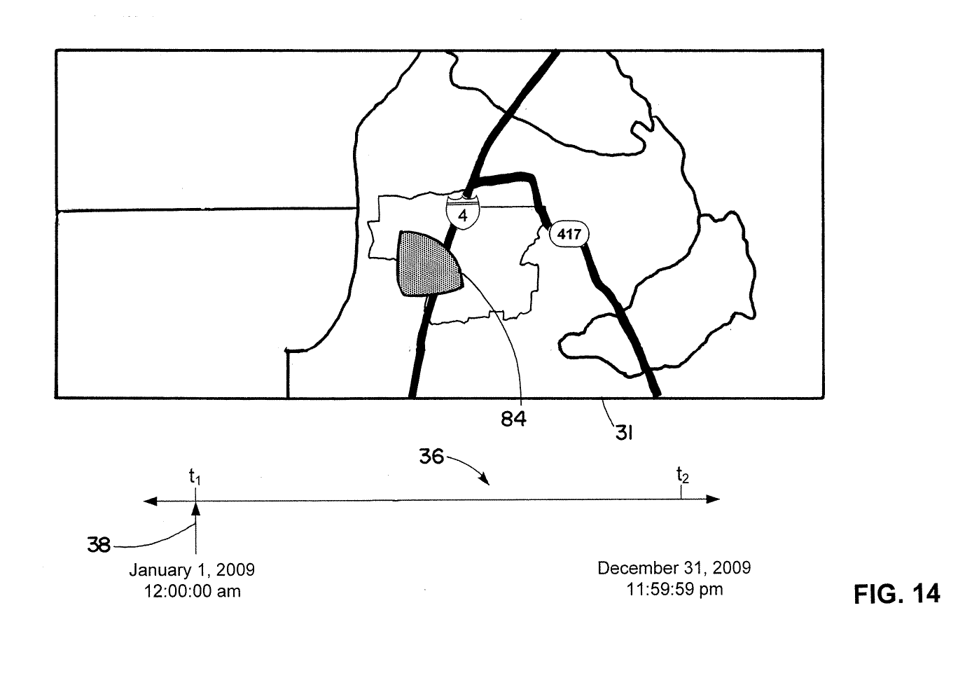

FIG. 14 depicts a map-based indication of the area in which DEF Internet intends to launch its application. The geographic boundary of DEF Internet's desired usage is indicated on the map by region 84. This figure is similar to the holder map of FIG. 7, insofar as the map of FIG. 14 displays a geographic area of interest and a graphical time display. If desired, the user may further specify a frequency range or other spectrum mask parameter, such as center frequency, and/or FCC part number appropriate for the application. FIG. 14, however, differs from FIG. 7 in that the indications in FIG. 14 represent the desired use by a prospective user rather than the actual or intended use of spectrum for the geographic area. A user may input a desired usage region on the map comparable to the ways by which a holder may enter information as described above. For example, a user may delineate the area on the map by drawing on the map using a touch screen surface, entering coordinates, using a graphics or illustrator application, or by other conventional means. Also, an automated tool may be used to construct boundaries of the area based on criteria or data relating to intended spectrum use that is supplied by the user. The time line 36 similarly may be interactive. For example, should the desired spectrum boundary be different or change at some time during the time window of the intended use, a user may move the time indication arrow 38 with a mouse pointer or similar input instrument and enter the altered spectrum information. It will be appreciated that various options may be provided for users to interact with the user maps.

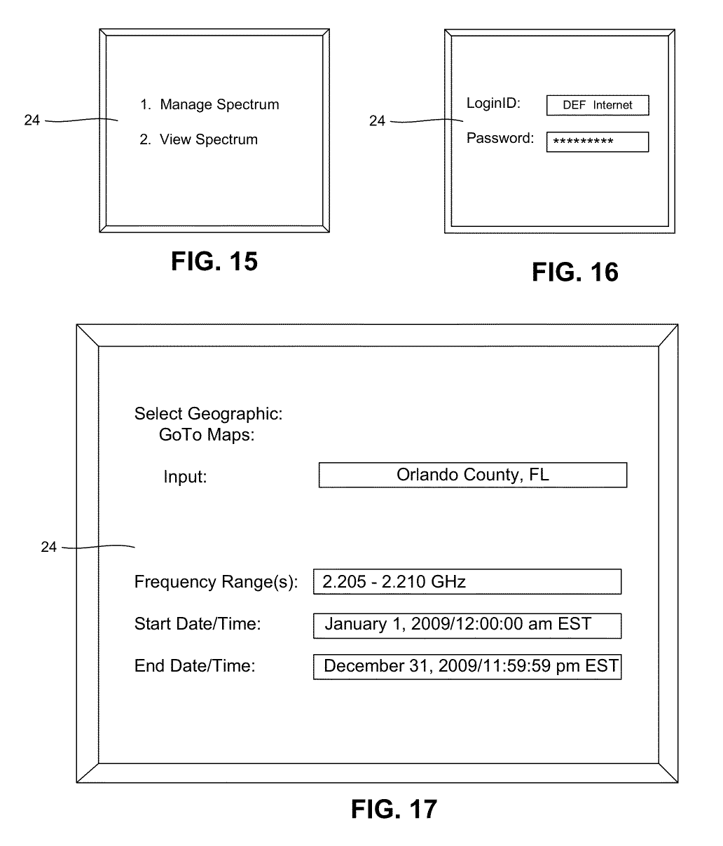

FIGS. 15-17 depict an exemplary user interface for spectrum users (and prospective users) to interface with the map-based spectrum usage manager application 43. FIGS. 15-17 are comparable to FIGS. 9-11, except FIGS. 15-17 provide an interface from a spectrum user perspective. The application 43 may be accessed by a user of the electronic device 20 or client device 21. It will be appreciated that the interface and menu system described below constitute an example and may be varied. Other interface systems having differing specific menus and format may be employed.

FIG. 15 depicts an exemplary opening screen as it may appear on the display 24 of an electronic device 20 or client device 21. A user may be provided, for example, with options such as “Manage” or “View” spectrum maps. In a first example, it will be assumed that a user selects the “Manage” option. Selections from this or other screen views described herein may be made from the display 24 using the input interface 28.

As described above, for a given user, managing spectrum use may include designating or blocking off desired spectrum for an intended use. As such, a user's management abilities would pertain only to the particular user's needs and applications. For example, DEF Internet may access only its own desired spectrum information for management purposes. Similarly, other users would have access only to their own desired spectrum information, but would not have access to managing DEF Internet's spectrum information. Accordingly, FIG. 16 depicts an exemplary login screen for managing desired spectrum. A user may input a login ID, password, and/or other security information to obtain access to management functions.

FIG. 17 depicts an exemplary data input screen from which a user may manually select a geographic area of interest. The geographic area may be input by typing in a geographic area, selecting a geographic area from a pull-down menu, or by other means, such as navigating a map. For example, as shown in FIG. 17, a user may have a “Go To Maps” option that permits a user to select a geographic area of interest from a national map or regions maps, similar to those of FIGS. 5A-5C. In this particular example, the user has employed the input option and typed in “Orlando County, Fla.” as an area of interest. The interface of FIG. 17 may also permit a user to input a desired frequency range, or channel, and a time window for which spectrum is desired. Additional criteria may be specified, such as transmission power, FCC part number or any other variable upon which the user's application may rely. Once a geographic area and other criteria are specified, a user may be presented with an interactive map of the selected geographic area, and may input desired spectrum usage as described above in connection with FIG. 14.

Referring again to FIG. 3, maps, desired spectrum information, and other related information may be stored in the electronic device 20, such as in memory 45. Such information also may be transformed or transmitted via the I/O interface 29 to various peripheral I/O devices, such as printers, faxes, external storage devices, and the like. Information may also be transmitted to other electronic devices via the network interface 22 over the communications system 68 (see FIG. 4) by any conventional means.

Referring again to FIG. 4, desired spectrum information and other related information may be transmitted over the network from client devices 21 and stored in the database 74. The information may then be accessed by client devices of holders, other users, prospective users, and other participants in the system.

Referring again to FIG. 15, a user may have the option of viewing maps of spectrum usage and/or desired spectrum without the management features. In other words, in the viewing mode a user would not be able to alter the desired spectrum use information. The viewer option for users may operate in a comparable manner as described above in connection with FIGS. 12 and 13 with respect to spectrum holders. Users, therefore, may view spectrum usage information relating to holders and other users to search for desired available spectrum.

With the described system and methods, users and perspective users may manage their desired spectrum information. In particular, users may generate map-based depictions of desired usage of spectrum and, as described below, relate the desired usage to map-based depictions of spectrum having use rights that are held by a spectrum holder. The map-based information may be accessed by other users and holders to identify favorable opportunities for transferring use rights for unused or underutilized spectrum.

Spectrum Usage and Availability Matching

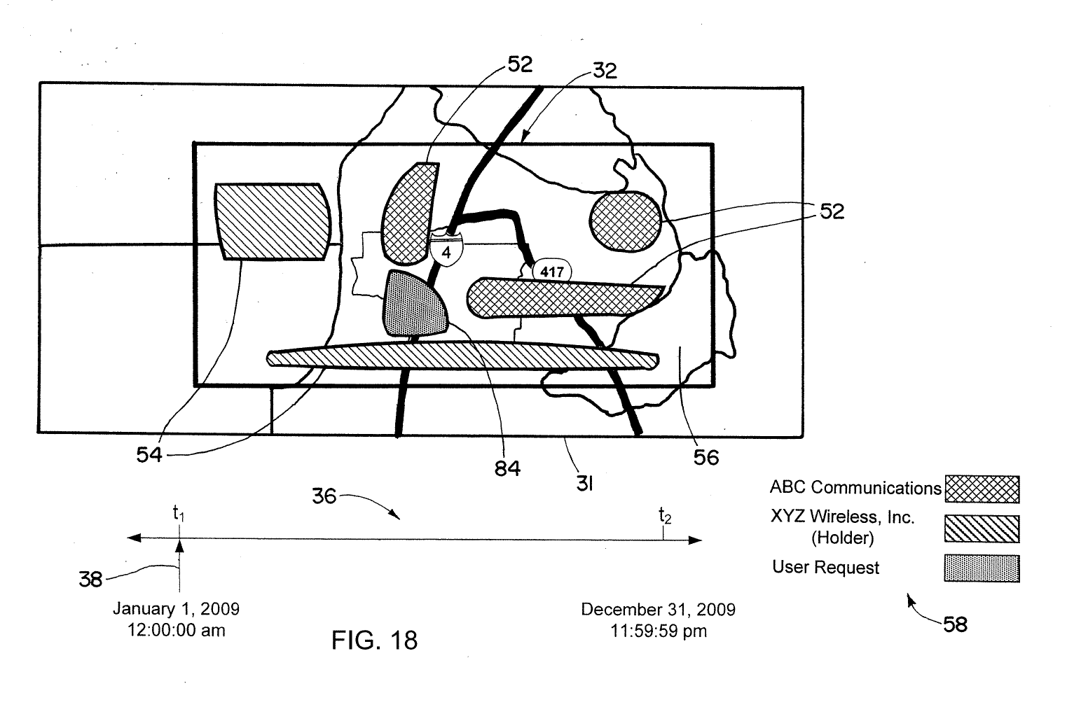

The disclosed systems and methods provide a convenient and efficient system for matching available spectrum of holders with spectrum usage needs of users. For example, FIG. 18 combines the holder spectrum use information of FIG. 7 and the user spectrum needs as depicted in FIG. 14. Like features are numbered the same in FIG. 18 as in the previous figures. In addition, the time range matches that of the user's spectrum needs for the purposes of a spectrum matching example, although the holder's time window may also be used.

As can be seen in FIG. 18, the user's desired spectrum region 84 appears on the map base 31 with the use regions 52 and 54, and the unused spectrum region 56. The legend also has an indication of the pattern corresponding to the user's desired spectrum, labeled as a “User Request”. The user's desired spectrum in this example overlaps and falls wholly within an area of unused spectrum, at least as of exemplary date Jan. 1, 2009. Accordingly, the user's desired spectrum constitutes available spectrum from the holder's viewpoint, and therefore spectrum use rights may be transferred from the holder to the user. The time line may be used to verify whether the availability remains across the user's desired time range. If not, partial spectrum use rights may be transferred for the time period or periods in which the spectrum segment is available. Also, if the user's desired spectrum overlaps with both available spectrum and used spectrum, partial spectrum use rights may be transferred.

Spectrum matching may be performed in a variety of ways. In one embodiment, users and holders may match spectrum manually, using visual observation. For example, holders that might offer spectrum use rights may view user desired spectrum information (such as that contained in FIG. 14) for the geographic, frequency, and time boundaries of available spectrum. By comparing such information, a holder may determine whether a user seeks the same spectrum that the holder has deemed or determined to be available, or may make available under opportune circumstances. A holder may then offer rights to the matched spectrum to the user. Conversely, a user seeking to acquire spectrum use rights may view holder available spectrum information (such as that contained in FIGS. 7 and 8) for the geographic, frequency, and time boundaries of the desired spectrum. By comparing such information, a user may determine whether a holder has available spectrum that meets the user's criteria. The user may then request or bid for use rights in the matched spectrum.

In other embodiments, the system may include automated matching features. For example, referring to FIG. 4, holder available spectrum information and user desired spectrum information may be stored in a network database, such as the database 74. The holder and user information may then be compared automatically by the application 43. When a match is found, the application 43 may transmit an alert to the corresponding holder and/or user. For example, alerts may be sent via the network of FIG. 4 to client holder and user devices 21 as Internet web-page content, emails, text messages, etc.

It will be appreciated that “matched spectrum” need not constitute a complete overlap of holder available spectrum and user desired spectrum. A partial overlap may occur because the desired spectrum is not available over the complete geography, time, and/or frequency desired. The system may also provide indications or alerts to holders and users when there is some proportional overlap of available and desired spectrum. The set proportion may be varied, and may be set by the users and/or holders based on their criteria. For example, suppose a user determines that the desired spectrum is actually available for only eighty percent of the desired geographic area. A user still may wish to request or bid on rights to the available portion given the substantial availability, even though the scope of rights may not be optimal. In such situations, circumstances may permit the parties to explore adjusting availability and/or proposed usage to arrive at a compromise or accommodation. Also, additional spectrum may be sought from another holder to combine spectrum so as to accomplish the user's goals. By accounting for partial overlaps, users and holders may still explore transfers for spectrum rights when initial circumstances indicate that desired spectrum is not fully available.

The disclosed system and methods, therefore, provide a convenient and efficient map-based system for identifying favorable opportunities for transferring spectrum use rights for a partitioned, disaggregated, and/or time sliced portion of a holder's spectrum. Holders may disseminate usage and availability information for their spectrum. In addition, users and prospective users may disseminate information regarding desired spectrum. Available spectrum use rights of holders may then be matched to the desired spectrum of users. Rights to use matched spectrum may then be transferred from a holder to a user.

It will be appreciated that any of the maps may be manipulated for enhanced viewing of the displayed content. For instance, panning and zooming features may be made available. Also, the view may be altered from an aerial view to a perspective view or an elevational view.

Although certain embodiments have been shown and described, it is understood that equivalents and modifications falling within the scope of the appended claims will occur to others who are skilled in the art upon the reading and understanding of this specification.

What is claimed is:

1. A method of comparing used spectrum and spectrum in which use rights are desired to conduct wireless communications, comprising:
identifying a spectrum block in which a first party has transferrable spectrum use rights for an entirety of the spectrum block, the spectrum block defined in terms of time, frequency and geographic area;
identifying one or more used portions of the spectrum block, each used portion being an apportioned segment of the spectrum block in that the used portion is at least one of partitioned from the spectrum block in terms of geography, disaggregated from the spectrum block in terms of frequency and sectioned from the spectrum block in terms of time, and wherein the one or more used portions change over the time defining the spectrum block based on at least one of changing spectrum use by the first party and allocations of spectrum from the first party to one or more other parties;
driving display of a geographic map of at least a portion of a geographic area of the spectrum block;
driving display of a used geographic region of the geographic area for each used portion of the spectrum block together with an available geographic region of the geographic area over the geographic map and each region displayed in a respective location in which the region geographically relates to the geographic map, the available geographic region being a portion of the geographic area that is unused and available for use by a second party; and
driving display of a desired spectrum region over the geographic map in a location in which the desired spectrum region geographically relates to the geographic map, the desired spectrum region for a geographic area of the spectrum in which use rights are desired to conduct wireless communications.

2. The method of claim 1, further comprising:
for each used portion of the spectrum block, generating a geographic buffer surrounding an area of actual spectrum use, wherein the used geographic region is the area of actual spectrum use and the respective geographic buffer; and
for the geographic area of the spectrum in which use rights are desired to conduct wireless communications, generating a geographic buffer surrounding an area of desired spectrum use, wherein the desired spectrum region is the area of desired spectrum use and the respective geographic buffer; and
wherein the geographic buffers are drawn with consideration to interference avoidance among spectrum users.

3. The method of claim 2, further comprising revising the displayed used geographic region, available geographic region and desired spectrum region to match spectrum use and desired use conditions for a user-specified time in the future.

4. The method of claim 1, further comprising revising the displayed used geographic region, available geographic region and desired spectrum region to match spectrum use and desired use conditions for a user-specified time in the future.

5. A computer-based spectrum management system, comprising a processor that executes logical instructions to:
identify a spectrum block in which a first party has transferrable spectrum use rights for an entirety of the spectrum block, the spectrum block defined in terms of time, frequency and geographic area;
identify one or more used portions of the spectrum block, each used portion being an apportioned segment of the spectrum block in that the used portion is at least one of partitioned from the spectrum block in terms of geography, disaggregated from the spectrum block in terms of frequency and sectioned from the spectrum block in terms of time, and wherein the one or more used portions change over the time defining the spectrum block based on at least one of changing spectrum use by the first party and allocations of spectrum from the first party to one or more other parties;
drive display of a geographic map of at least a portion of a geographic area of the spectrum block;
drive display of a used geographic region of the geographic area for each used portion of the spectrum block together with an available geographic region of the geographic area over the geographic map and each region displayed in a respective location in which the region geographically relates to the geographic map, the available geographic region being a portion of the geographic area that is unused and available for use by a second party; and
drive display of a desired spectrum region over the geographic map in a location in which the desired spectrum region geographically relates to the geographic map, the desired spectrum region for a geographic area of the spectrum in which use rights are desired to conduct wireless communications.

6. The computer-based spectrum management system of claim 5, wherein the processor further executes code to:
for each used portion of the spectrum block, generate a geographic buffer surrounding an area of actual spectrum use, wherein the used geographic region is the area of actual spectrum use and the respective geographic buffer; and
for the geographic area of the spectrum in which use rights are desired to conduct wireless communications, generate a geographic buffer surrounding an area of desired spectrum use, wherein the desired spectrum region is the area of desired spectrum use and the respective geographic buffer; and
wherein the geographic buffers are drawn with consideration to interference avoidance among spectrum users.

7. The computer-based spectrum management system of claim 6, wherein the processor further executes code to revise the displayed used geographic region, available geographic region and desired spectrum region to match spectrum use and desired use conditions for a user-specified time in the future.

8. The computer-based spectrum management system of claim 5, wherein the processor further executes code to revise the displayed used geographic region, available geographic region and desired spectrum region to match spectrum use and desired use conditions for a user-specified time in the future.
